(19) United States
(12) Patent Application Publication
(10) Pub. No.: US 2014/0213089 A1
(43) Pub. Date: Jul. 31, 2014

(54) PLUG CONNECTOR

(71) Applicant: Pierre Ueberschlag, Dietwiller (FR)

(72) Inventor: Pierre Ueberschlag, Dietwiller (FR)

(73) Assignee: MULTI-HOLDING AG, Allschwil (CH)

(21) Appl. No.: 14/345,862

(22) PCT Filed: Sep. 13, 2012
(86) PCT No.: PCT/EP2012/067942

§ 371 Date: Apr. 17, 2014

(30) Foreign Application Priority Data
Sep. 20, 2011 (EP) 11 182 003.1

(51) Int. Cl. H01R 13/58; H01R 13/648; H01R 13/52

(52) U.S. Cl. CPC H01R 13/582; H01R 13/5202; H01R 13/648
USPC 439/271; 439/460

(57) ABSTRACT

A detachable plug connector, in particular a multiple plug connector, comprising a plug side (1) having an insulating plug housing (10) and having a plug element (2) embedded in the plug housing (10) comprising a pin segment (20) and a contact segment (21) for the electrically conductive connection to an external element, in particular a cable, and a socket side (3) having an insulating socket housing (30) and having a socket element (4) embedded in the socket housing (3) having a socket segment (40) and a contact segment (41) for an electrically conductive connection to an external element, in particular a cable (9), wherein the plug housing (10) can be plugged together with the socket housing (30) in a plug direction (S), and whereby the pin segments (20) of the plug elements (2) protrude into the socket segments (40) of the socket elements (4) in a contacting region (K1, K2) in the plugged state so that an electrical contact can be conveyed between the socket side (3) and the plug side (1) via the socket segment (40) and the pin segment (20), wherein a multitude of socket housings (30) are arranged next to one another, wherein at least one physical protective element (5) is arranged in the socket housing (30) and in the plug housing (10) per pairing of plug element (2) and socket element (4), wherein the physical protective element (5) protects the corresponding pair of plug element (2) and socket element (4) from external influences.

### TECHNICAL FIELD

The present invention relates to an electric plug connector, in particular for use in electrically driven vehicles, according to the preamble of claim 1.

### PRIOR ART

Multiple or multipolar plug connectors, which comprise a plurality of connections arranged parallel to one another, are known from the prior art. Here, a plurality of electric connections, in particular of different polarities, can be provided by means of a single plug-in process.

However, the multiple or multipolar plug connectors known from the prior art have the disadvantage that they do not meet the requirements in the field of electric mobility. As a result of the use of these plug connectors, which are generally exposed to weather influences in an unprotected manner, moisture continuously infiltrates between the socket side and plug side, whereby the electric connection between the socket side and plug side and therefore reliability as a whole is compromised.

Further, there is also a risk that, in the case of multipolar plug connectors, problems may occur concerning the energy transmission or signal transmission, respectively, which could have fatal consequences, particularly in the field of vehicle technology. This is particularly the case with the transmission of signals which have an influence on the control of the vehicle.

### DISCLOSURE OF THE INVENTION

Proceeding from this prior art, the object of the invention is to specify a plug connector, in particular a multiple plug connector, which is reliably designed, such that malfunctions can be largely avoided. In addition, the plug connector in its form as a multiple plug connector is to be easily extendable in a modular manner.

This object is achieved by the plug connector according to claim 1. Accordingly, a detachable plug connector comprises a socket side having an insulating socket housing and having a socket element which is embedded in the socket housing and which has a socket portion and a contact portion for the electrically conductive connection to an external element, in particular a cable, and comprises a plug side having an insulating plug housing and having a plug element which is embedded in the plug housing and which has a pin portion and a contact portion for the electrically conductive connection to an external element, in particular a cable. The socket housing can be plugged together with the plug housing in a plug-in direction. In the plugged-together state, the pin portions of the plug elements protrude into the socket portions of the socket elements in a contacting region, such that an electrical contact can be conveyed between the socket side and plug side via the socket portion and pin portion. A plurality of socket housings are arranged adjacently to one another and a plurality of plug housings are arranged adjacently to one another. At least one physical protective element is arranged in the socket housing and in the plug housing per pairing of socket element and plug element, wherein the physical protective element protects the corresponding pair of socket element and plug element from external influences.

Consequently, each individual pair or each individual pole of the socket element and plug element is protected individually by the corresponding at least one protective element associated with the pair or the pole, respectively. This is particularly advantageous because on the one hand a modular design without adaptations on the socket side and plug side is necessary. Furthermore, each pole is protected separately, which is likewise advantageous. A multiple plug connector which functions more reliably on the whole can thus be provided.

Further embodiments are specified in the dependent claims.

### BRIEF DESCRIPTION OF THE DRAWINGS

Preferred embodiments of the invention will be described hereinafter with reference to the drawings, which serve merely for explanation and are not to be interpreted as limiting. In the drawings:

FIG. 1 shows a sectional view of a socket side and a plug side of a detachable multiple plug connector in the separated state in accordance with an embodiment of the invention;

FIG. 2 shows a sectional view of the plug connector according to FIG. 1 in the connected or plugged-together state;

FIG. 3 shows an enlarged view of the plug element according to FIG. 1;

FIG. 4 shows an enlarged view of the socket element according to FIG. 1;

FIG. 5 shows a plan view of the multiple plug in the connected state;

FIG. 6 shows a perspective view of the plug side according to FIG. 1;

FIG. 7 shows a perspective view of the socket side according to FIG. 1;

FIGS. 8a-8c show views of a protective element in the form of a first shielding element;

FIGS. 9a-9b show views of a protective element in the form of a second shielding element; and

FIG. 10 shows a perspective view of a plug connector in accordance with a further embodiment with a holding element;

FIG. 11 shows the view of FIG. 10 with separated holding element;

FIG. 12 shows the separated holding element according to FIGS. 10 and 11;

FIG. 13 shows a sectional illustration through the holding element according to FIGS. 10 to 12; and

FIG. 14 shows a sectional illustration according to FIG. 10 along the center axis of a cable.

### DESCRIPTION OF PREFERRED EMBODIMENTS

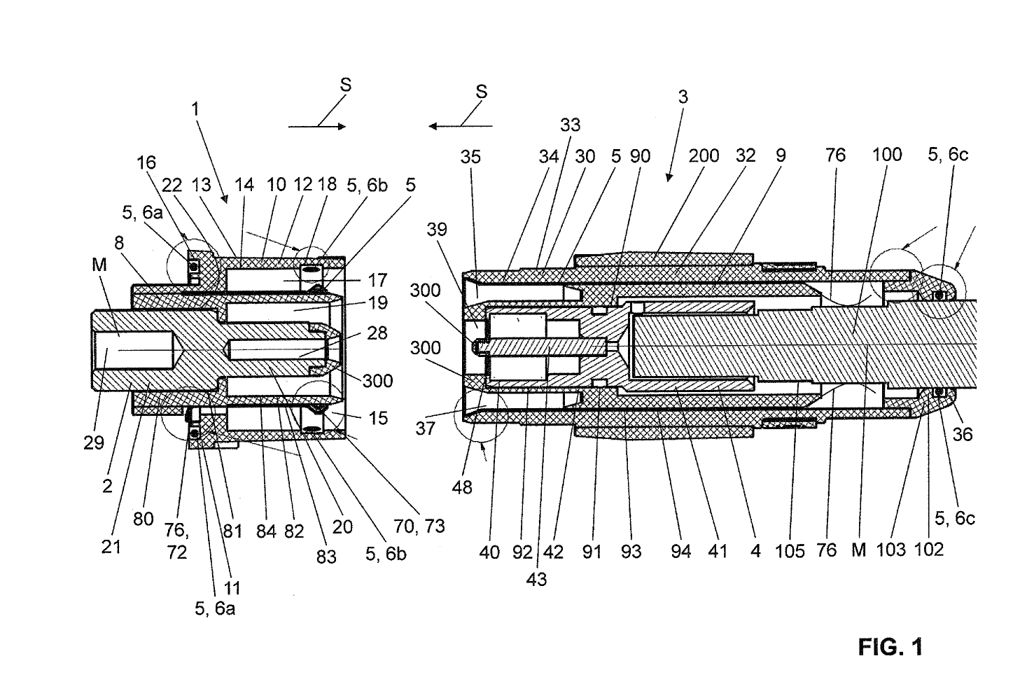

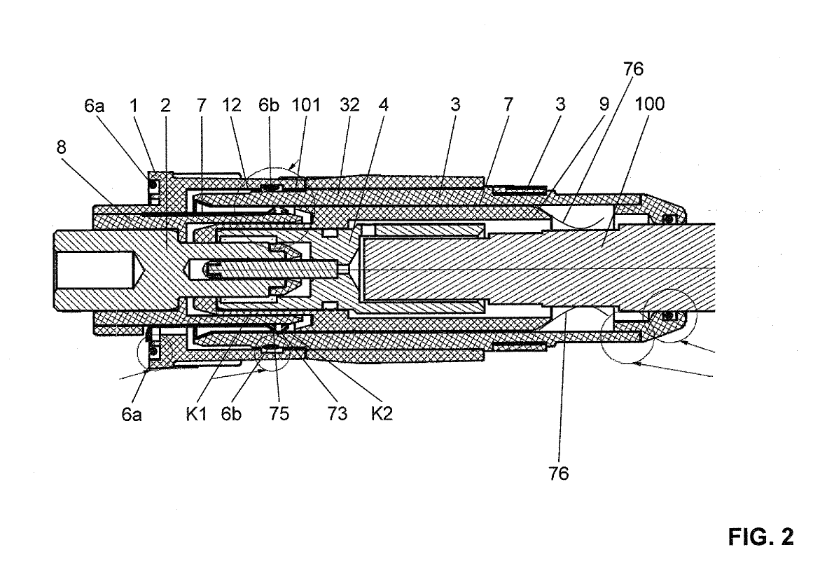

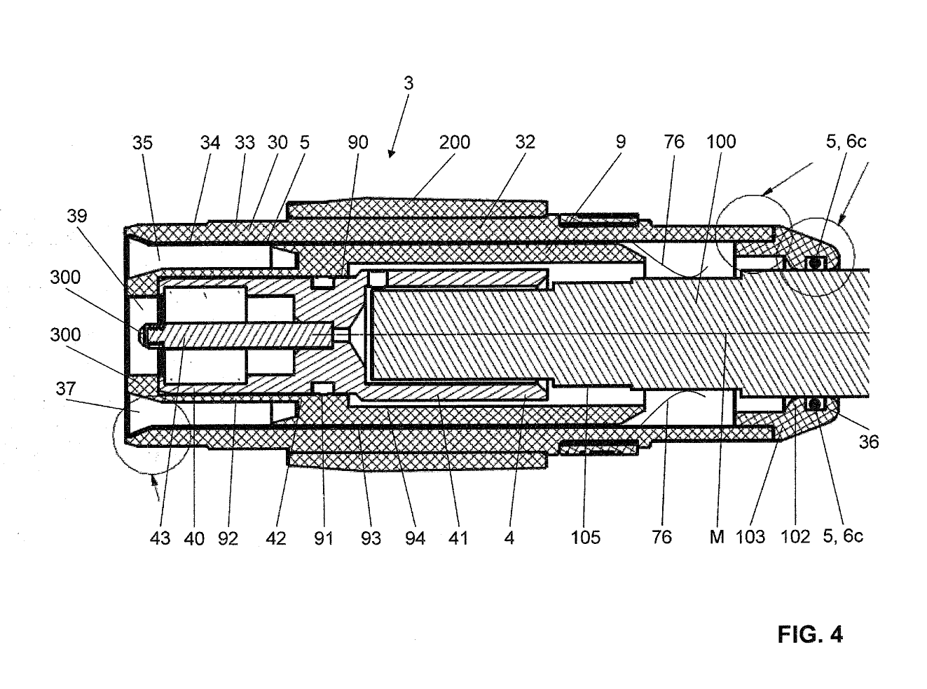

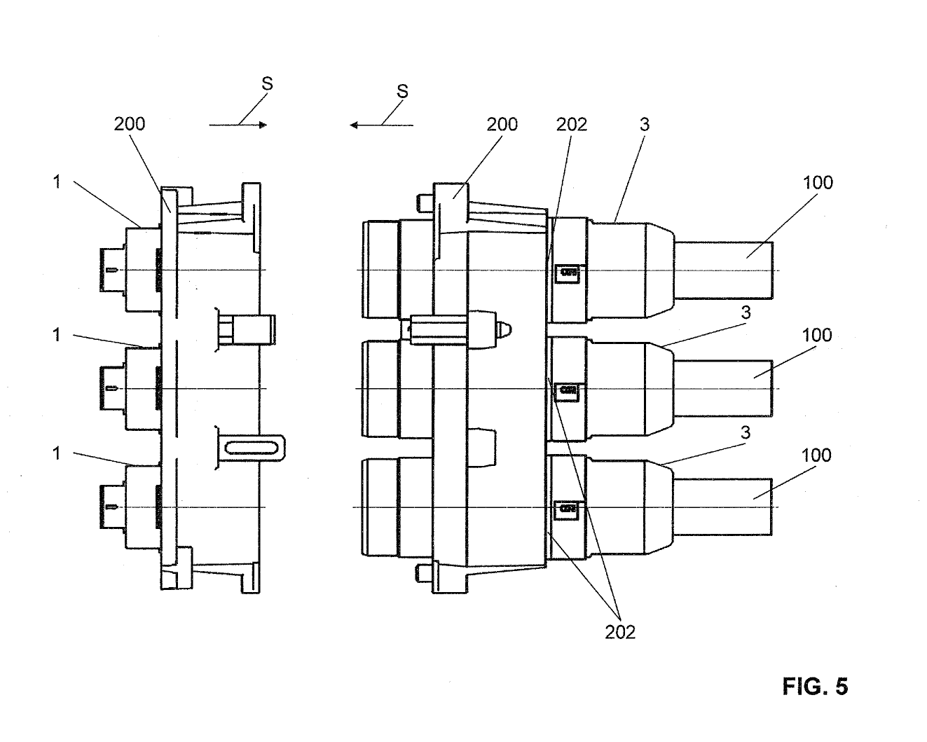

Sectional views of a pole of a plug connector or of a multiple plug connector are shown in FIGS. 1 to 4. The plug connector or multiple plug connector is shown in a plan view and a perspective view, respectively, in FIGS. 5 to 7.

The multiple plug connector here comprises three poles or plug connectors, respectively, arranged parallel to one another, wherein all three poles or plug connectors can be interconnected by means of a single plug-in process. A multiple plug connector is understood to mean a plug connector via which a number of poles, in particular of different potential, can be switched simultaneously. Alternatively, it is also possible for just a single pole to be provided, reference then being made to a plug connector. The plug side 1 and the socket side 3 herein are electrically conductively connected to an electrically conductive external element. The electrically conductive external element in particular is a cable 100 or an electric device, for example a battery or an actuator, etc. Consequently, a number of poles can thus be connected accordingly by a single plug-in connection or plug-in movement, respectively. The poles serve both for energy transmission and signal transmission.

The plug side 1 comprises an electrically insulating plug housing 10, preferably made of plastic, and a plug element 2 embedded in the plug housing 10. A plurality of plug housings 10 may be arranged adjacently to one another and/or may be connected to one another, wherein each of the plug elements 2 then constitutes a corresponding pole. The plug elements 2 comprise a pin portion 20 and a contact portion 21. Here, the contact portion 21 is electrically conductively connected to the above-mentioned external element, and the pin portion 20 serves for the contacting of electrically conductive parts on the socket side 3.

The socket side 3 comprises an electrically insulated socket housing 30, preferably made of plastic, and a socket element 4 embedded in the socket housing 30. A plurality of socket housings 30 can be arranged adjacently to one another and/or can be interconnected, wherein each of the socket elements 4 then constitutes a corresponding pole. The socket elements 4 comprise a socket portion 40 and a contact portion 41. Here, the contact portion 41 serves for the electrically conductive connection to an external element, in particular to a cable 100. For example, the cable 100 is a copper cable or an aluminum cable. The socket portion 40 forms the above-mentioned electrically conductive part, and the pin portion 20 protrudes into the socket portion 40, wherein the electrical contact between the plug side 1 and the socket side 3 is then conveyed via the socket portion 40 and pin portion 20.

The plug housing 10 and the socket housing 30 can be plugged together. The plug-in movement is performed here in a plug-in direction S as is shown in FIG. 1. Here, the plug-in direction runs parallel to the socket portions 40 and the pin portions 20 or parallel to the respective center axis M of the socket portion 40 and pin portion 20, respectively. In the plugged-together state, the pin portions 20 of the plug elements 2 protrude into the socket portions 40 of the socket elements 4 and an electrical contact is thus conveyed between the socket side 3 and plug side 1.

At least one physical protective element 5 is arranged in the plug housing 10 per plug element 2 and is associated with the corresponding plug element 2. At least one physical protective element 5 is likewise arranged in the socket housing 30 per socket element 4 and is associated with the corresponding socket element 4. Consequently, each plug element 2 and each socket element 4 comprises at least one separate protective element 5 of its own associated with the respective plug element 2 or socket element 4 respectively. In other words, it can be said that, per pole provided from a single plug element 2 and a single socket element 4, one protective element 5 associated with the pole is provided and protects the corresponding pole. The physical protective element 5 protects the pole or the plug element 2 associated with the pole, respectively, and the socket element 4 associated with the pole from external influences, in particular from fluids or electromagnetic fields.

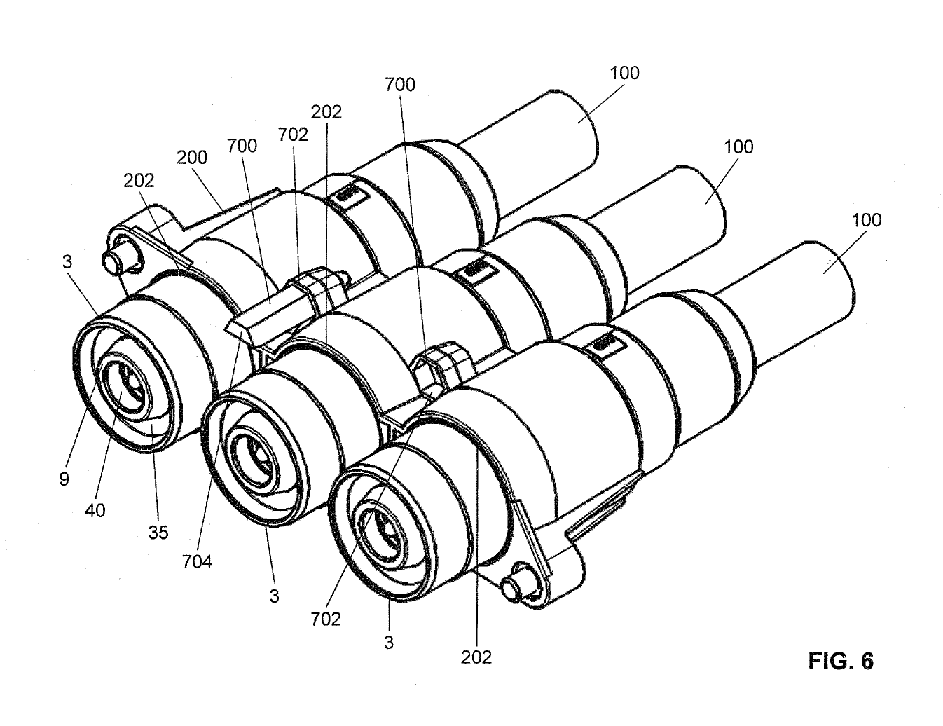

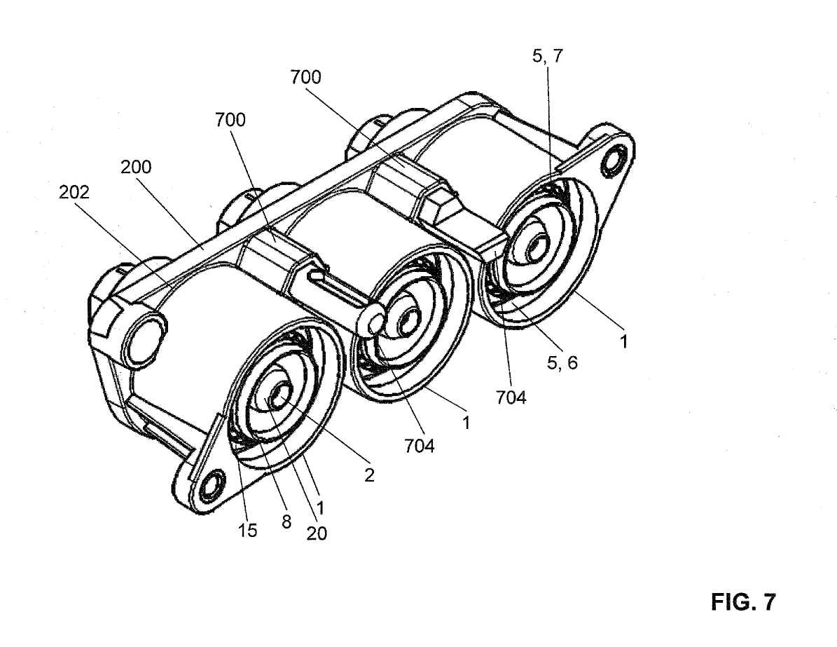

The plug side 1 will now be explained in greater detail with reference to FIGS. 1 to 3. As explained above, the plug side 1 essentially comprises a plug housing 10, a plug element 2 and at least one physical element 5. A plurality of plug housings 10 comprising the corresponding elements are arranged here adjacently to one another, as shown in FIGS. 5 and 7.

The plug housing 10 is designed substantially rotationally symmetrical about the center axis M and has the form of a hollow cylinder with a peripheral side wall 12. Here, the side wall 12 has an outer face 13 and an inner face 14 facing toward the interior 15 of the hollow cylinder. The interior 15 delimited by the side wall 12 serves basically to receive the plug element 2 and parts of the socket side 3. The plug element 2 is mounted here in the plug housing 10 via a mounting element 8. Here, the mounting element 8 is connected to the plug housing 10. The plug element 2 is mounted in the mounting element 8 fixedly with respect to a movement in the direction of the center axis. For this purpose, the mounting element 8 has an opening 80 running centrally through the mounting element 8. Similarly to the plug housing 10, the mounting element 8 is also substantially rotationally symmetrical. The opening 80 basically has two portions, specifically a mounting portion 81 and a contact portion 82. Here, the contact portion 82 basically provides the contacting region K1 together with the corresponding elements of the plug side 3.

Alternatively, the plug element 2 may also be arranged directly, that is to say without the mounting element 8, in the interior 15 of the plug housing 10.

The design of the plug element 2 can also be seen clearly in FIG. 1. As already described above, the plug element 2 comprises a pin portion 20 and a contact portion 21. Here, the plug element 2 is designed substantially rotationally symmetrical about its center axis M and extends along the center axis M. Here, the pin portion 20 comes to rest in the contact portion 82 of the opening 80 in the mounting element 8, and the contact portion 21 comes to rest in the mounting portion 81. An electrical contact is then provided in the contact portion 82 between the external element, for example a cable, which is not illustrated here, and the plug element 2. The plug element 2 is mounted in the plug housing, here in the mounting portion 81, via a mounting portion 22, which is located between the socket portion 20 and the contact portion 21. Here, the pin portion 20 protrudes into the socket element 4 and thus produces the electrical contact between the socket side 3 and plug side 1. The pin portion 20 further comprises an opening 28 for receiving a bolt 43.

In the region of the contact portion 21, the plug element 2 further has an opening 29 here. The external element, for example the cable, can be inserted into this opening 29, where it can be mechanically or integrally electrically conductively connected to the plug element 2.

The design of the socket side 3 will now be explained with the aid of FIGS. 1, 2 and 4. The socket housing is designed substantially rotationally symmetrical about the center axis M and has the form of a hollow cylinder with a side wall 32. Here, the side wall 32 has an cuter face 33 and an inner face 34 facing toward the interior 35 of the hollow cylinder. The interior 35 delimited by the side wall 32 serves basically to receive the socket element 4 and parts of the socket side 1 in the plugged-together state. Here, the socket element 4 is mounted in the socket housing 30 via a mounting element 9. The mounting element 9 is connected here to the socket housing 30. The socket element 4 is mounted in the mounting element 9 fixedly with respect to a movement in the direction of the center axis. For this purpose, the mounting element 9 has an opening 90 running centrally through the mounting element 9. Like the plug housing 10, the mounting element 9 is also designed substantially rotationally symmetrical. The opening 90 essentially has two portions, specifically a mounting portion 91 and a contact portion 92. Here, the contact portion 92 essentially provides the contacting region K1 together with the corresponding elements of the plug side 1.

In the socket portion 40, the socket element 4 has a socket opening 48, which extends along the center axis M of the socket element 2. This socket opening 48 serves to receive the pin portion 20 of the plug element 2. An electrically conductive contact element (not illustrated here), which conveys an electrical contact between the plug element 2 and socket element 4, is preferably arranged in the socket opening 48. The contact element preferably has the form of a contact lamella, wherein the contact lamella comprises a plurality of deflecting webs. As the plug side and socket side are plugged together, these webs are then pressed against the wall of the socket opening 48 by the pin portion 20 and thus convey an electrical contact between the socket opening 48 and pin portion 20. Furthermore, a bolt 43, which on the one hand serves as a guiding bolt and on the other hand functions as a contact prevention means, extends into the socket opening 48, such that it is not possible to reach into the socket opening 48. In the connected state, the bolt 43 protrudes into the opening 28 of the plug element 2.

The physical protective element 5 preferably has the form of a sealing element 6 and/or the form of a shielding element 7.

The physical protective element in the form of at least one sealing element 6, also denoted in the figures by 6a to 6c, will now be explained with reference to FIGS. 1 to 4. Here, the sealing elements 6 seal the interior 15 with the plug element 2 of the plug housing 10 and the interior 35 with the socket element 4 of the socket housing 30 from external influences, in particular from the infiltration of fluids, such as air and water. Here, the sealing effect is provided in the plugged-together or in the assembled state, respectively, that is to say when the socket side 3 is connected to the plug side 1. In particular, the contacting region K1, that is to say the region in which the pin portion 20 protrudes into the socket portion 40, is sealed with respect to the fluids.

Each individual pair of plug element 2 and socket element 4 is sealed here separately from and independently of an adjacent pair of plug element 2 and socket element 4, which enables the modular design of a plurality of adjacently arranged pairs or socket side 3 and plug side 1, respectively, without further adaptations. In other words, it can also be said that, with a multiple plug connector comprising a plurality of socket sides 3 or plug sides 1, respectively, arranged side by side or adjacently to one another, each pole or each pair, respectively, is sealed separately. Each contact region between the plug element 2 and socket element 4 is therefore sealed separately.

The at least one sealing element 6 can be arranged differently. An advantageous arrangement will now be presented with reference to FIGS. 1 to 4.

The plug side shown in FIG. 1 has a flange 11 protruding from the plug housing 10, in particular from the outer face 13. This flange 11 serves as a fastening element for fastening to a further external element, for example a housing (not illustrated in the figures) of an electric device, for example to a housing of a vehicle. Here, the connection between the housing and the plug housing 10 forms an interface, wherein provisions for providing tightness are to be provided on the housing side. The portion between the flange 11 and the housing is sealed here by the sealing element 6a. To receive the sealing element 6a, the flange 11 has a receiving element 16, which here has the form of a groove running annularly in the flange. In other embodiments, the groove may also run in an angular manner. The sealing element 6a is thus arranged in the receiving element 16. The flange 11 is optional, wherein the plug side is then formed in a substantially analog manner to the socket side regarding the sealing features.

A further sealing element 6b is arranged between the plug housing 10 and the socket housing 30, wherein the sealing element 6 in the plugged-together state seals the gap 101 between the plug housing 10 and socket housing 30. The inner face 14 of the plug housing 10 preferably has a receiving element 18, here a groove which extends in the side wall 12 and is intended to receive the sealing element 6b. In the plugged-together state, the sealing element 6b comes into contact with the outer face 33 of the socket housing 30, whereby the gap 101 between the inner face 14 of the plug housing and outer face 33 of the socket housing 30 is sealed.

In the present embodiment, the sealing element 6b is directed or arranged, respectively, toward the interior of the plug housing 10, in particular toward an annular interspace 17, which is provided by the inner face 14 of the plug housing 10 and by the outer face 83 of the mounting element 8. Alternatively, the sealing element 6b may also be arranged on the outer face 33 of the socket housing 30.

Alternatively, the socket side 3, that is to say the socket housing 30, may also be provided with a corresponding flange if the socket side 3 is to be connected to an external element, for example to a housing.

At least one sealing element 6c is arranged on the plug side between the external element 100, in particular the cable, and the socket housing 30. This sealing element 6c thus seals the gap 102 between the socket housing 30 and the external element 100. This arrangement may also be implemented accordingly on the plug side 1. Here, the sealing element 6c lies in a receiving element 36 in the form of a groove, which is arranged on the housing 30.

In the present embodiment, the socket housing 30 in the rear region has an optional adaptor element 103, which is inserted into the socket housing 30 and is connected thereto. The adaptor element 103 may likewise have a seal (not shown here), which seals the gap between the housing 30 and adaptor element 103. In the present embodiment the receiving element 36 is integrally formed on the adaptor element 103, but may also be integrally formed directly on the housing 30 if the optional adaptor element 103 is not provided.

Reference will now be made to FIGS. 1 to 4 and 8 to 9, on the basis of which the physical protective element 5 in the form of the shielding element 7 will be explained. As mentioned above, the physical protective element 5, additionally or alternatively to the sealing element 6, may have the form of a shielding element 7 which provides protection from external or internal influences, in particular electromagnetic fields. Here, the shielding element 7 individually surrounds each of the plug elements 2 or socket elements 4, respectively, and the corresponding pair of plug element 2 and socket element 4 is thus protected with respect to external influences. In other words, it can also be said that each individual pole consisting of a single plug element 2 and a single socket element is individually surrounded and shielded by the shielding element 7. The shielding serves as a protective element or shielding from the outside in and from the inside out.

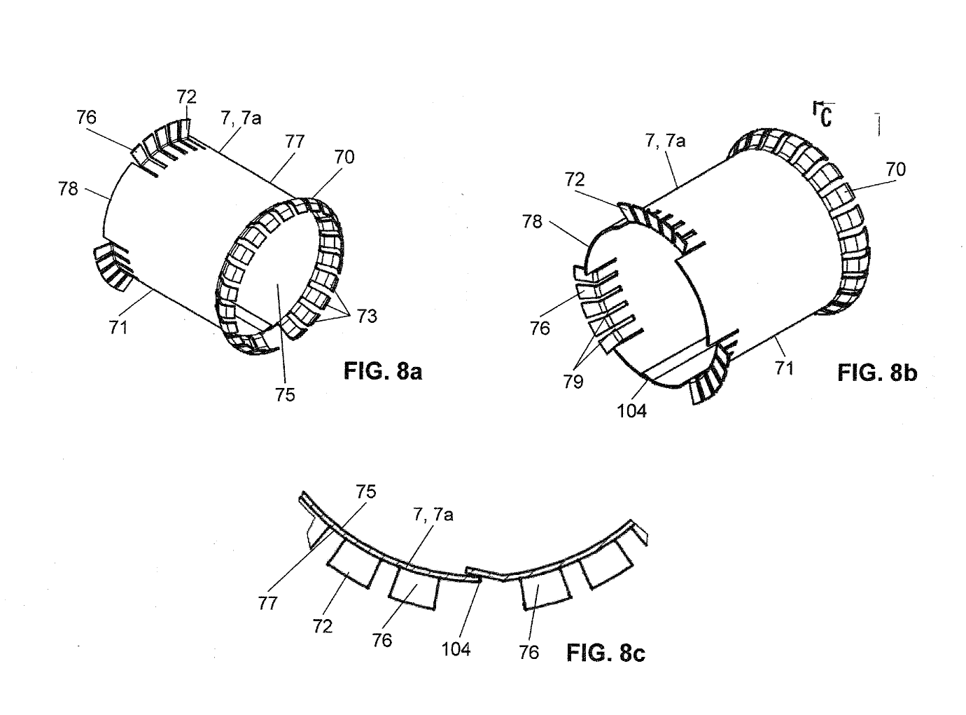

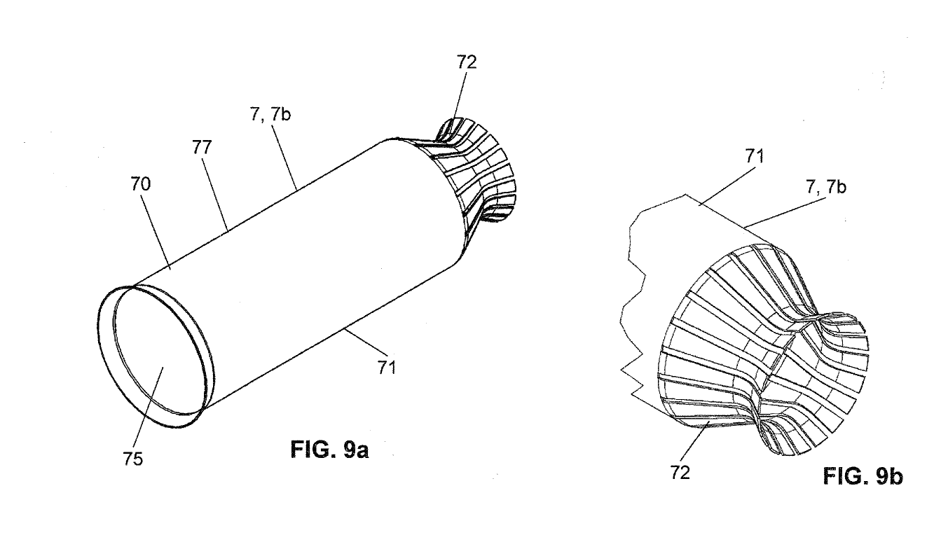

Two different embodiments of a shielding element 7 are shown in FIGS. 8a to 8c and 9a to 9c. The shielding element 7a according to FIGS. 8a to 8c is preferably used in the plug side 1 whereas the shielding element 7 according to FIGS. 9a to 9b is preferably used in the socket side 2.

In accordance with both embodiments, the shielding element 7 comprises a contact portion 70, an adjoining mounting portion 71 and a connection portion 72 adjoining the mounting portion 71. In principle, the shielding element 7 is designed substantially rotationally symmetrical about the center axis M.

The contact portion 70 serves to electrically conductively contact another shielding element 7. Here, the contact portion 70 of the shielding element 7a is connected to the contact portion 70 of the shielding element 7b. Consequently, two shielding elements 7, for example the shielding element 7a according to FIGS. 8a to 8c and the shielding element 7b according to FIGS. 9a to 9b, can thus make contact with one another via the contact portion 70. Furthermore, the contact portion 70 also serves for the shielding of external influences.

The mounting portion 71 basically serves for the mounting of the shielding element 7 in the plug housing 10 or in the socket housing 30 and preferably has the form of a peripheral hollow cylinder comprising an inner face 75 and an outer face 77. Furthermore, the mounting portion 71 also serves for the shielding of external influences.

The connection portion 72 serves to electrically conductively connect the shielding element to the shielding of an external element, for example of a cable 100 or the corresponding shielding elements of a housing. Here, the connection portion 72 protrudes at least in part into the region of the flange 11.

It can be clearly seen in FIGS. 8a to 8c that the contact portion 70 of the shielding element 7a has the form of tabs 73 extending at an angle to the plug-in direction S. The tabs 73 extend over a first portion away from the outer face 77 or away from the center axis M, respectively, such that the diameter of all tabs 73 becomes larger. Over a second portion, the tabs 73 then in turn extend toward the center axis M, such that the diameter of all tabs 73 becomes smaller again. It can also be said that, in cross section perpendicularly to the center axis M, the tabs 73 are therefore bent outwardly in an arched manner with respect to the outer face 77. Alternatively, the tabs 73 may also extend in the plug-in direction S. A plurality of tabs 73 is arranged around the periphery of the hollow cylinder, preferably at regular distances from one another.

The tabs 73 are preferably designed in a resilient manner, such that the tabs 73 can be moved with respect to the center axis M and can return again to the original position once a corresponding force ceases. A particularly good and reliable contacting can thus be obtained due to these resilient properties.

In FIGS. 9a to 9b it can be clearly seen that the contact portion 70 of the other shielding element 7 has the form of a hollow-cylindrical inner wall or inner face 75. When the plug side 1 is plugged together with the socket side 3, the tabs 73 are thus in contact with the inner face 75 of the hollow cylinder. As the tabs 73 are inserted into the hollow cylinder, they deflect accordingly and endeavor to move back into the original position, thus ensuring that the tabs 73 are always in contact with the contact portion 70, such that the shielding remains continuously contacted. During production of the plug-in connection, the tabs 73 preferably come into contact with a cone 74, which is arranged in front of the contact portion as viewed in the plug-in direction S. Here, the cone ensures good deflection of the tabs 73.

The shielding element 7 is preferably arranged in such a way that, during the plug-in cycle, the shielding elements 7, 7a, 7b contact the plug element 2 before the socket element 4 is contacted. During the unplugging cycle, the contacting of the shielding elements 7, 7a, 7b consequently occurs after the separation of the electrical connection between the socket element 4 and plug element 2. The contacting between the shielding element of the socket side 3 and of the plug side 1 forms a further contacting region K2.

Alternatively, the contact portion 70 can also be formed conically instead of in the form of the hollow cylinder.

The connection portion 72 preferably has the form of connection tabs 76. The connection tabs 76 are then electrically conductively connected to the shielding of an external element, for example to the shielding 105 of the cable 100 or to the shielding of a housing.

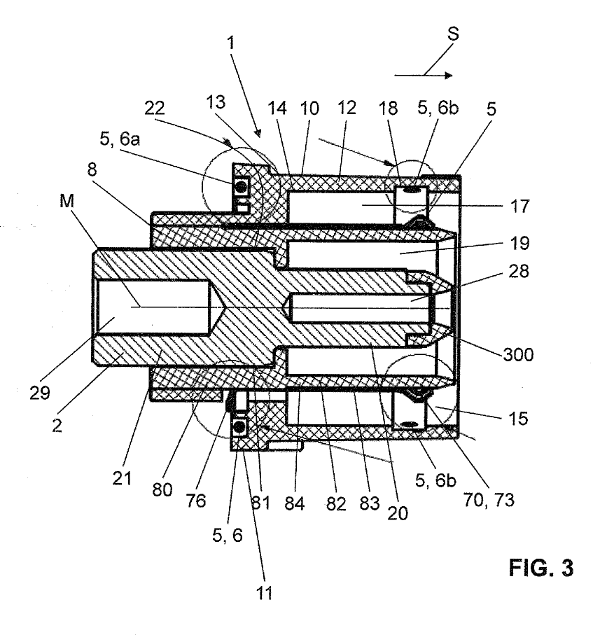

The connection tabs 76 according to the embodiment of the shielding element 7a according to FIGS. 8a to 8c extend outwardly in the installed state at right angles to the center axis M. Another orientation is also conceivable depending on the case of application, wherein the connection tabs 76 are deformable during the installation process. It can be clearly seen in FIGS. 1 and 3 how the connection tabs 76 protrude from the plug housing 10. For this purpose, the plug housing 10 has corresponding openings. The connection tabs 76 are arranged here in a manner distributed in groups over the periphery of the shielding element 7 or of the hollow cylinder, respectively. In the present embodiment three groups comprising a plurality of connection tabs 76 are provided. It is also conceivable to provide just one group, two groups or more than three groups.

As viewed in the direction of the center axis M, the connection tabs 76 are set back slightly with respect to a front edge 78 of the hollow cylinder and slots 79 extend from the connection tabs 76 into the hollow cylinder. These features essentially have the advantage that the shielding element 7 can be easily produced.

The connection tabs 72 according to the embodiment of the shielding element 7 according to FIGS. 9a to 9b are formed in such a way that they extend at an angle to the plug-in direction S, such that the clearance between the opposed connection tabs 72 becomes smaller over a first portion with increasing distance from the mounting portion 71 and becomes larger again over a second optional portion with increasing distance from the mounting portion 71.

The shielding element 7, 7a, 7b is preferably produced from a punched part which is deformed accordingly after the punching process. It can be clearly seen in FIG. 8c that the shielding element has an overlap region 104, where the punched part is joined together suitably after the deforming or reshaping process, respectively. Here, the overlap region 104 provides a mechanical guide and closes the shielding element 7, 7a, 7b completely, such that a good shielding effect is ensured.

The installation of the shielding elements 7, 7a, 7b in the plug side 1 or in the socket side 3, respectively, will now be presented in the following. As already explained above, the plug side 1 preferably has a mounting element 8, which surrounds the plug element 2 and which is in turn surrounded by the socket housing 10. Here, the mounting element 8 protrudes via a hollow-cylindrical wall 84 into the interior 15 between the plug housing 10 and plug element 2. This interior 15 is thus divided by the mounting element 8, whereby an interspace 17 and 19 is provided. The interspace 17 serves to receive parts of the socket housing 30. The interspace 19 basically serves to receive the mounting element 9 of the plug side 3.

The same can also be said for the socket side 2, wherein a mounting element 9 protrudes here into the interior 35 of the socket housing 30 and divides this interior accordingly, such that an interspace 37 and 39 is produced. The interspace 37 serves to receive parts of the plug housing 10, here the mounting element 8. The interspace 39 serves to receive parts of the plug element 2.

The shielding element 7 is preferably mounted on the outer face 83, 93 of the wall 84, 94 of the corresponding bearing element 8, 9. The bearing element 8, 9 is therefore consequently connected to the shielding element 7. Alternatively or simultaneously, the shielding element 7 may also be mounted on the inner face 14 of the side wall 12 of the plug housing 10 or on the inner face 34 of the side wall 32 of the plug housing 10. In the present embodiment the shielding element 7 is fixed between the corresponding mounting element 8, 9 and the side wall 12, 32 of the socket housing 30 or of the plug housing 10 respectively.

The shielding element 7 is preferably arranged with respect to the sealing element 6 in such a way that the shielding element 7 is protected from external influences. The protective element 5 in the form of the sealing element 6 thus accordingly seals the shielding element 7 from fluids.

It can be clearly seen in FIGS. 5 to 7 that the plug connector preferably comprises a housing frame 200 having a plurality of receiving openings 202. The socket housing 30 or the plug housing 10, respectively, are mounted in the receiving openings 202. The housing frame 200 thus serves basically for the arrangement of socket housings 30 and plug housings 10 adjacently to one another. The receiving openings 202 preferably extend in the plug-in direction S. Both the socket side 3 and the plug side 1 comprise a corresponding housing frame 200.

An optional coding element 700 is arranged on the housing frame 200 of the socket side 3 and on the housing frame 200 of the plug side 1. The coding element has the advantage that it prevents incorrect plugging. The coding element 700 preferably extends from one of the housing frames 200 in the plug-in direction S, whereas the other housing frame has a corresponding coding element 700. The arrangement of a coding element 700 prevents the multiple plug from being plugged together incorrectly, and thus prevents a polarity reversal. Here, the coding elements 700 may be formed such that they can be plugged in modularly, wherein for this purpose the coding element 700 has corresponding openings 702, into which pins 704 can be plugged. The openings 702 preferably have a hexagonal cross section, into which both a hexagonal pin and a round pin can be plugged. Here, the hexagonal pin serves as a coding element as such, whereas the round pin may also serve as a guide element or as an anti-twist element.

The socket housing 10 and plug housing 30 are preferably formed from a material that does not conduct electric current, such as plastic.

The above-described features in respect to the socket side 3 and plug side 1 can also be clearly seen in FIGS. 6 and 7. Here, it can additionally be seen that the mounting elements 8, 9 not only have the above-described functions, but simultaneously serve as protection against contact, such that it is not possible for the electrically conductive element to be grasped by hand. In this respect, it is also noted that the plug element 2 and socket element 4 are provided with corresponding protective caps 300 made of an insulating material, such that the protection against contact is improved further.

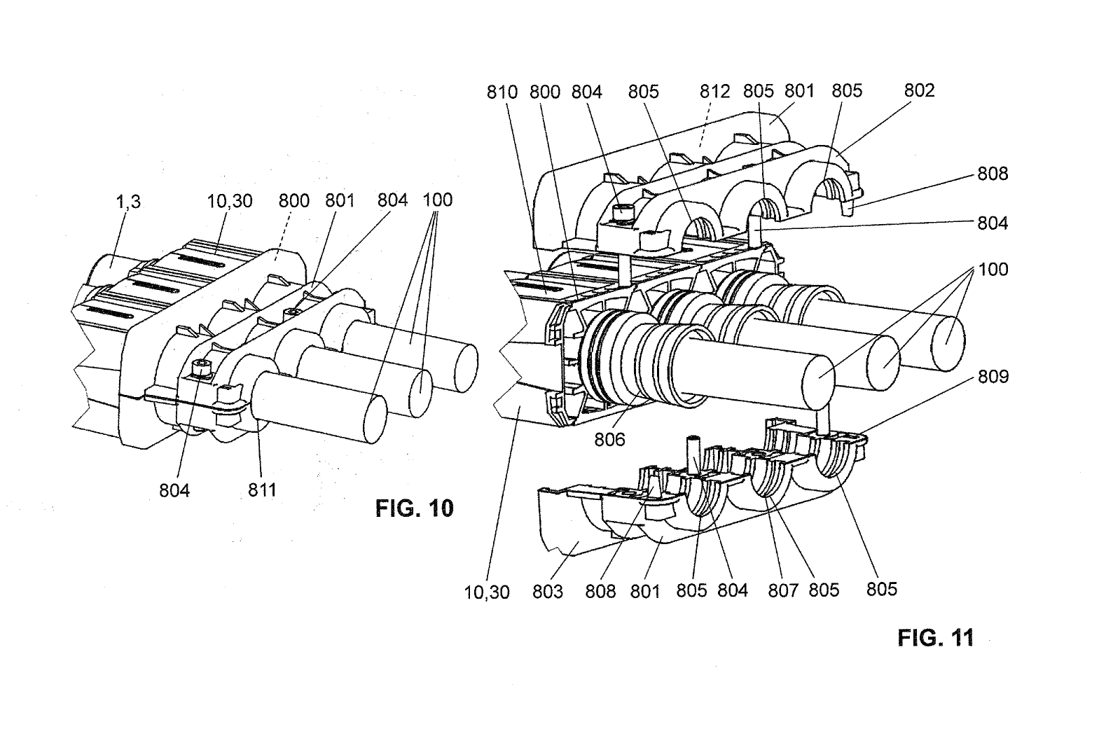

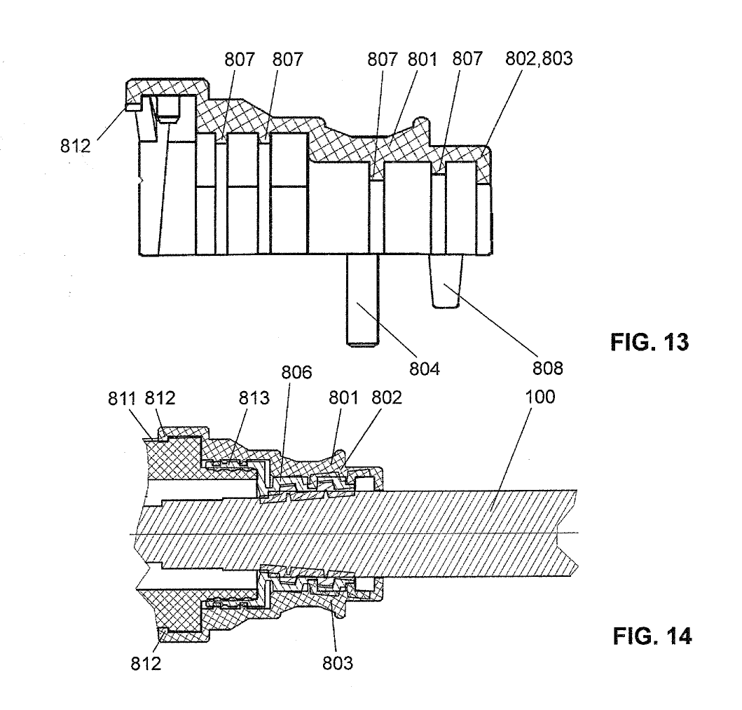

A further embodiment of a physical protective element will now be presented with reference to FIGS. 10 to 14. Like parts are provided with like reference signs, which applies in particular for the plug side 1 and for the socket side 3. The protective element 5 is connected to the plug side 1 and to the socket side 3, wherein the plug side 1 and socket side 3 are formed substantially in accordance with the previously described embodiments. In this further embodiment the protective element 5 has the form of a holding element 801.

The plug housing 10 and also the socket housing 30, as in FIG. 11, comprise a receiving portion 800 for fastening or connecting, respectively, the physical protective element 5 to the plug housing 10 and to the socket housing 30. The physical protective element 5 has the form of a holding element 801. In addition, the external element 100 in this embodiment has the form of a cable 100 protruding from the plug housing 10 or the socket housing 30, respectively. The holding element 801 acts on the cable 100. Here, the holding element 801 supports the cable 100, such that there can be no kinking in the region of the plug housing 10 or of the socket housing 30, respectively. Furthermore, the holding element 801 may also constitute a strain relief for the cable 100 when the holding element 801 clamps the cable 100 accordingly.

The holding element 801 comprises a first holding part 802 and a second holding part 803, both holding parts 802, 803 being connectable to at least one connection element 804. The two holding parts 802, 803 support or clamp the cable 100, respectively. The connection element 804 may be a screw, for example. The connection element protrudes here through openings 814 in the holding parts 802, 803.

Each of the holding parts 802, 803 preferably has a recess 805, which corresponds substantially to the cross section of the cable 100 to be received.

In the present embodiment three recesses 805 are arranged side by side for a triple-pole plug. It is also possible however to design the holding parts 802 for a one-pole plug, wherein only one recess 805 is then provided.

One of the holding parts 802 comprises at least one positioning pin 808, and the other of the holding parts 803 comprises at least one positioning opening 809. The positioning pin 808 protrudes into the positioning opening (809), whereby the two holding parts 801, 802 can be aligned relative to one another.

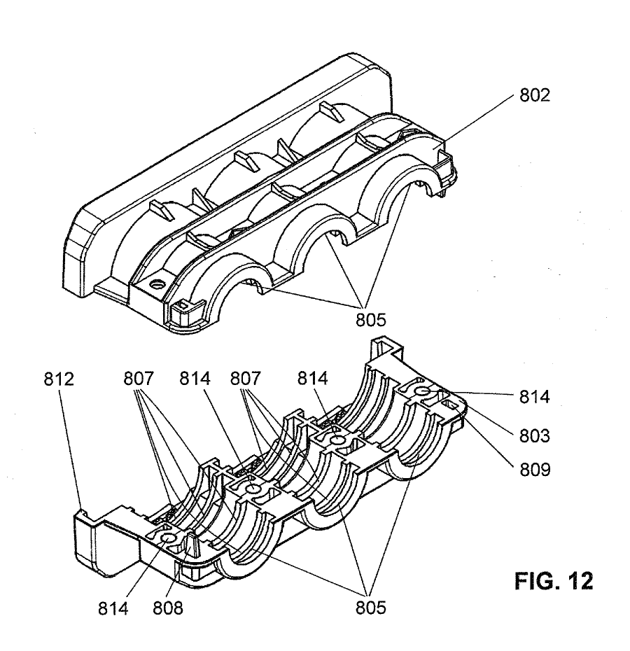

The recess 805, as can be clearly seen in FIGS. 12 to 14, is provided with at least one protrusion 807, preferably with a plurality of protrusions 807 arranged at a distance from one another. As viewed in cross section, the protrusions 807 run substantially perpendicularly to the center axis M of the cable 100. The protrusions serve to apply a clamping force to the cable 100, such that the latter can be secured with respect to the plug housing 10 or the socket housing 30, respectively, via the holding element 801.

It can also be seen clearly from FIG. 11 and FIG. 14 that a sleeve 806 extending around the cable 100 is arranged between the holding element 801 and the cable 100. The holding element 801 acts on the cable 100 via the sleeve 806. As a result, a clamping force is transmitted via the sleeve 806.

The sleeve 806 is formed for example from a rubber-like material or a comparatively soft plastic.

The receiving portion 800 has a recess 811 arranged on the outer face 810 of the plug housing 10 or of the socket housing 30. This recess can be clearly seen in FIGS. 11 and 14. The holding element 801 has a ridge 812, which engages in the recess 811. When the holding element 801 is connected to the socket housing 30 or the plug housing 10, respectively, the ridge 812 engages in the recess 811, whereby a connection is produced between the housing 10 or 30, respectively, and holding element 801. This is thus an interlocking connection.

It can also be seen from FIG. 14 that the holding element 801 can be additionally clamped onto the housing 10, 30 via an optional clamping portion 813. Here, the sleeve 806 preferably likewise extends into this clamping portion 813.

To summarize, the following advantages of the present invention can be noted:
Due to the arrangement of the protective element, a multiple plug that is more robust and more resistant with respect to external influences can be provided.
It is further advantageous to provide, per pole, that is to say per pairing of plug element and socket element, a corresponding protective element associated with this pole, wherein the modularity of the multiple plug can thus be improved accordingly.
In addition, a varied modular arrangement of socket elements and plug elements is possible.

List of reference signs

| | |
|---|---|
| 1 | socket side |
| 2 | plug element |
| 3 | plug side |
| 4 | socket element |
| 5 | protective element |
| 6 | sealing element |
| 7 | shielding element |
| 8 | mounting element |
| 9 | mounting element |
| 10 | socket housing |
| 11 | flange |
| 12 | side wall |
| 13 | outer face |
| 14 | inner face |
| 15 | interior |
| 16 | receiving element |
| 17 | interspace |
| 18 | receiving element |
| 19 | interspace |
| 20 | pin portion |
| 21 | contact portion |
| 22 | mounting portion |
| 29 | opening |
| 30 | socket housing |
| 32 | side wall |
| 33 | outer face |
| 34 | inner face |
| 35 | interior |
| 37 | interspace |
| 36 | receiving element |
| 38 | socket opening |
| 39 | receiving element |
| 40 | socket portion |
| 41 | contact portion |
| 42 | mounting portion |
| 43 | bolt |
| 48 | socket opening |
| 70 | contact portion |
| 71 | mounting portion |
| 72 | connection portion |
| 73 | tabs |
| 74 | cone |
| 75 | inner face |
| 76 | connecting tabs |
| 77 | outer face |
| 78 | front edge |
| 79 | slot |
| 80 | opening |
| 81 | mounting portion |
| 82 | contact portion |
| 83 | outer face |
| 84 | wall |
| 90 | opening |
| 91 | mounting portion |
| 92 | contact portion |
| 93 | outer face |
| 94 | wall |
| 100 | cable |
| 101 | gap |
| 102 | gap |
| 103 | adaptor element |
| 104 | overlap region |
| 105 | cable shielding |
| 200 | housing frame |
| 202 | receiving openings |
| 300 | protective caps |
| 700 | coding element |
| 702 | openings |
| 704 | pins |
| 800 | receiving portion |
| 801 | holding element |
| 802 | first holding part |
| 803 | second holding part |
| 804 | connecting element |
| 805 | recess |
| 806 | sleeve |
| 807 | protrusion |
| 808 | positioning pin |
| 809 | positioning opening |
| 810 | outer face |
| 811 | recess |
| 812 | ridge |
| 813 | clamping portion |
| 814 | openings |
| K1 | contacting region |
| K2 | contacting region |
| | shielding |
| S | plug-in direction |
| M | center axis |

1. A detachable plug connector comprising
a plug side (1) having an insulating plug housing (10) and having a plug element (2), which is embedded in the plug housing (10) and which has a pin portion (20) and a contact portion (21) for the electrically conductive connection to an external element, in particular a cable, and comprising
a socket side (3) having an insulating socket housing (30) and having a socket element (4), which is embedded in the socket housing (30) and which has a socket portion (40) and contact portion (41) for the electrically conductive connection to an external element, in particular a cable (100),
wherein the plug housing (10) can be plugged together with the socket housing (30) along a plug-in direction (S), and wherein, in the plugged-together state, the pin portions (20) of the plug elements (2) protrude into the socket portions (40) of the socket elements (4) in a contacting region (K), such that an electrical contact can be conveyed between the socket side (3) and plug side (1) via the socket portion (40) and pin portion (20),
characterized in that
at least one physical protective element (5) is arranged in the plug housing (10) and in the socket housing (30) per plug element (2) and socket element (4), wherein the physical protective element (5) protects the corresponding pair of plug element (2) and socket element (4) from external influences.

2. The detachable plug connector as claimed in claim 1, characterized in that the plug housing (10) and socket housing (30) each comprise at least one receiving portion (800) for fastening the physical protective element (5) to the plug housing (10) and to the socket housing (30), wherein the physical protective element (5) has the form of a holding element (801), and the external element (100) is a cable (100) protruding from the plug housing (10) or the socket housing (30), wherein the holding element (801) acts on the cable (100) outside the plug housing (10) or the socket housing (30), respectively.

3. The detachable plug connector as claimed in claim 2, characterized in that the holding element (801) comprises a first holding part (802) and a second holding part (803), both holding parts (802, 803) being connectable to at least one connecting element (804), wherein the two holding parts (802, 803) support or clamp the cable (100), respectively.

4. The detachable plug connector as claimed in claim 3, characterized in that the holding part (802, 803) has a recess (805) which corresponds substantially to the cross section of the cable (100) to be received.

5. The detachable plug connector as claimed in claim 3 or 4, characterized in that one of the holding parts (802) comprises at least one positioning pin (808) and the other of the holding parts (803) comprises at least one positioning opening (809), wherein the positioning pin (809) protrudes into the positioning opening (809) and the two holding parts (801, 802) can thus be aligned relative to one another.

6. The detachable plug connector as claimed in claim 5, characterized in that the recess (805) is provided with at least one protrusion (807), preferably with a plurality of protrusions (807), which, as viewed in cross section, runs substantially perpendicularly to the center axis (M) of the cable (100).

7. The detachable plug connector as claimed in one of claims 2 to 6, characterized in that a sleeve (806) extending around the cable (100) is arranged between the holding element (801) and the cable (100), wherein the holding element (801) acts on the cable (100) via the sleeve (806), wherein the sleeve (806) extends preferably in portions over the plug housing (10) or the socket housing (30) and is additionally clamped relative to the plug housing (10) or socket housing (30) by the holding element (801) in a clamping portion (813).

8. The detachable plug connector as claimed in one of claims 2 to 7, characterized in that the receiving portion (800) is a recess (811) arranged on the outer face (810) of the plug housing (10) or of the socket housing (30), wherein the holding element (801) has a ridge (812), which engages in the recess (811), and/or wherein the holding element (801) is clamped relative to the plug housing (10) or relative to the socket housing (30) in a clamping portion (813).

9. The detachable plug connector as claimed in one of the preceding claims, characterized in that the physical protective element (5) has the form of at least one sealing element (6), which seals the interior (15) with the plug element (2) of the plug housing (10) and seals the interior (35) with the socket element (4) of the socket housing (30), in particular the contacting regions (K1, K2), with respect to external influences, in particular preventing the infiltration of fluids.

10. The detachable plug connector as claimed in claim 9, characterized in that the plug housing (10) and/or the socket housing (30) has a flange (11) which protrudes from the corresponding housing (10, 30) and has a receiving element (16) for at least one sealing element (6), wherein the sealing element (6) can be arranged against a surface of a further element, such as a housing, said surface running parallel to the flange (11), and in so doing seals the portion between the surface and flange (11).

11. The detachable plug connector as claimed in one of claims 9 to 10, characterized in that a sealing element (6) is arranged between the plug housing (10) and the socket housing (30) and seals the gap (101) between the plug housing (10) and socket housing (30), wherein the inner face (14) of the plug housing (10) preferably has a receiving element (18) for receiving at least one sealing element (6), and wherein the sealing element (6) in the plugged-together state comes into contact with an outer face (33) of the socket housing (30), whereby the gap between the inner face (14) and outer face (13) is sealed.

12. The detachable plug connector as claimed in one of claims 9 to 11, characterized in that at least one sealing element (6) is arranged between the external element (100), in particular the cable, and the plug housing (10) and/or the socket housing (30).

13. The detachable plug connector as claimed in one of the preceding claims, characterized in that the physical protective element (5) has the form of a shielding element (7, 7a, 7b), which in each case individually surrounds each of the plug elements (2) or each of the socket elements (4), respectively, and thus shields the corresponding pair of plug element (2) and socket element (4) from external influences, in particular electromagnetic fields.

14. The detachable plug connector as claimed in claim 13, characterized in that the shielding element (7, 7a, 7b) comprises a contact portion (70), a mounting portion (71) and a connection portion (72), wherein the contact portion (70) serves to electrically conductively contact a further shielding element (7, 7b, 7a), wherein the mounting portion (71) serves to mount the shielding element (7, 7a, 7b) in the plug housing (10) or in the socket housing (30), respectively, and wherein the connection portion (72) is electrically conductively connected to a shielding of an external element, in particular a cable or a housing.

15. The detachable plug connector as claimed in one of claims 13 to 14, characterized in that the contact portion (70) of one shielding element (7, 7a, 7b) has the form of tabs (73) extending in the plug-in direction (S) and/or at an angle to the plug-in direction (S), and in that the contact portion (70) of the other shielding element (7) has the form of a hollow-cylindrical inner face (75) or the form of a cone having an inner face (75), wherein an electrically conductive contact can be produced between said inner face (75) and tabs (73).

16. The detachable plug connector as claimed in one of claims 13 to 15, characterized in that the connection portion (72) has the form of connecting tabs (76) extending in the plug-in direction (S) and/or at an angle to the plug-in direction (S), wherein the connecting tabs (76) extend in particular at right angles to the plug-in direction, or wherein the connecting tabs (76) extend at an angle to the plug-in direction, such that the clearance between the connecting tabs (76) becomes smaller over a first portion with increasing distance from the mounting portion (71) and becomes larger again over a second optional portion with increasing distance from the mounting portion (71).

17. The detachable plug connector as claimed in one of claims 13 to 15, characterized in that the connection portion (72) is guided out from the plug housing (10) and/or from the socket housing (30), such that the connection portion (72) can be connected to the shielding of an external element.

18. The detachable plug connector as claimed in one of the preceding claims, characterized in that the plug side has a mounting element (8), which surrounds the plug element (2) and which is in turn surrounded by the plug housing (10), wherein the mounting element (8) protrudes with a hollow-cylindrical wall (84) into the interior (15) between the plug housing (10) and plug element (2) and thus divides this interior (15), whereby an interspace (17) is provided, and/or
in that the socket side (3) has a mounting element (9), which surrounds the socket element (4) and which is in turn surrounded by the socket housing (30), wherein the mounting element (9) protrudes with a hollow-cylindrical wall (94) into the interior (35) between the socket housing (30) and socket element (4) and thus divides this interior (35), whereby an interspace (37) is provided.

19. The detachable plug connector as claimed in one of claims 13 to 18, characterized in that the outer face (83, 93) of the wall (84, 94) of the mounting element (8, 9) supports parts (71) of the shielding element (7), and/or in that the inner face (14) of the side wall (12) of the plug housing (10) supports parts (71) of the shielding element (7), and/or in that the inner face (34) of the side wall (32) of the socket housing (30) supports parts (71) of the shielding element (7).

20. The detachable plug connector as claimed in one of the preceding claims, characterized in that the plug connector comprises a housing frame (200) having a plurality of receiving openings (202), wherein the plug housing (10) or the socket housing (30), respectively, are mounted in the receiving openings (202), wherein the receiving openings (202) preferably extend in the plug-in direction (S).

21. The detachable plug connector as claimed in one of the preceding claims, characterized in that the shielding element (7) is arranged with respect to the sealing element (6) in such a way that the shielding element (7) is protected from external influences.

22. The detachable plug connector as claimed in one of the preceding claims, characterized in that a plurality of plug housings (10) are arranged adjacently to one another, and wherein a plurality of socket housings (30) are arranged adjacently to one another, wherein each of the plug housings (10) comprises a plug element (2) and each of the socket housings (3) comprises a socket element (3).
